(19) United States
(12) Patent Application Publication
(10) Pub. No.: US 2007/0147079 A1
(43) Pub. Date: Jun. 28, 2007

(54) BACKLIGHT MODULE WITH MULTIPLE LIGHT SOURCES

(75) Inventors: Meng-chai Wu, Jhubei City (TW); Chi-chung Lo, Yongjing Township (TW); Chin-kun Hsieh, Hsinchu City (TW); Cheng-chih Lai, Changhua City (TW); Chih-Chen Cheng, Ershuei Township (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: AU Optronics Corp., Hsin-Chu (TW)

(21) Appl. No.: 11/425,186

(22) Filed: Jun. 20, 2006

(30) Foreign Application Priority Data
Dec. 23, 2005 (TW) 094146292

(51) Int. Cl. F21V 7/04

(52) U.S. Cl. 362/612; 362/615

(57) ABSTRACT

A backlight module with a plurality of light sources is provided. The backlight module includes a bezel, a first light emitting diode disposed at one side of the bezel for emitting light, a second light emitting diode for emitting light, and a light guiding plate disposed on the bezel for guiding light from the first and second light emitting diodes. The light axis of the first light emitting diode is not parallel to that of the second light emitting diode.

### BACKGROUND OF THE INVENTION

1. Field of the Invention

The present invention relates to a backlight module, and more particularly, to a backlight module using light emitting diodes as light sources.

2. Description of the Related Art

A backlight module is a key component of a liquid crystal display (LCD). The purpose of the backlight module is to provide a sufficient brightness and an even distributing light surface to the LCD panel. Because LCD is widely used in various electronic products such as monitors, notebook computers, digital cameras, and projectors, the demand for the backlight module has increased tremendously.

In recent years, in addition to a cold cathode fluorescent lamp (CCFL) used as a light source, light emitting diodes (LEDs) are increasingly used in medium to large size liquid crystal displays. Please refer to FIG. 1, which shows a display range of the light emitting diodes (12) of the conventional backlight module 10. Traditionally, a plurality of light emitting diodes 12 with an illuminated region of 110 degrees (as indicated by angle A) are disposed at a side of bezel 16. That is, it is inevitable that dark areas 100 to be viewed as a result of a defect in display quality. Therefore, please refer to FIG. 2, which shows a diagram of luminous region of a prior art backlight module 14. Despite using more LED 12 at the side of bezel 16 provides a resolution to dark area 100, it also raises the cost. Furthermore, such design is not worthy of manufacturing low luminance displays.

Accordingly, please refer to FIG. 3, which shows a diagram of luminous region of another prior art backlight module 20. Differing from backlight module 10, the light emitting diodes 22 of backlight module 20 is disposed at the corners of bezel 26. In this manner, two light emitting diodes 22 or even a light emitting diode 22 is sufficient for covering desired viewing region of active area 28. Yet, such backlight module succeeds in having least possible insufficient illumination.

### SUMMARY OF INVENTION

Accordingly, an object of the invention is to provide a backlight module having a plurality of LEDs disposed at a side of a bezel. By adjusting the alignment of the LEDs, using fewer LEDs is sufficient for covering desired viewing region of the active area, in order to solve the above-mentioned problem.

Briefly summarized, a backlight module comprises a bezel, a first light emitting diode disposed at one side of the bezel for emitting light, a second light emitting diode disposed at the same side of the bezel for emitting light, and a light guiding plate disposed on the bezel for guiding light from the first and second light emitting diodes. The light axis of the first light emitting diode is not parallel to that of the second light emitting diode.

According to the claimed invention, a backlight module comprises a bezel, a first light emitting diode group, a second light emitting diode group and a light guiding plate. The first light emitting diode group comprises a first light emitting diode and a second light emitting diode disposed at one side of the bezel, wherein the first light emitting diode has a light axis which is not parallel to a light axis of the second light emitting diode. The second light emitting diode group comprises a third light emitting diode and a fourth light emitting diode disposed at the same side of the bezel, wherein the third light emitting diode has a light axis which is not parallel to a light axis of the fourth light emitting diode. The light guiding plate, disposed on the bezel, is used for guiding light from the first and second light emitting diode groups.

According to the claimed invention, a backlight module comprises a bezel, a plurality of light emitting diode groups disposed at one side of the bezel, and a light guiding plate disposed on the bezel. Each light emitting diode group comprises a first light emitting diode and a second light emitting diode, wherein the first light emitting diode has a light axis which is not parallel to a light axis of the second light emitting diode. The light guiding plate is used for guiding light from the plurality of light emitting diode groups.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a display range of the light emitting diodes of the conventional backlight module.

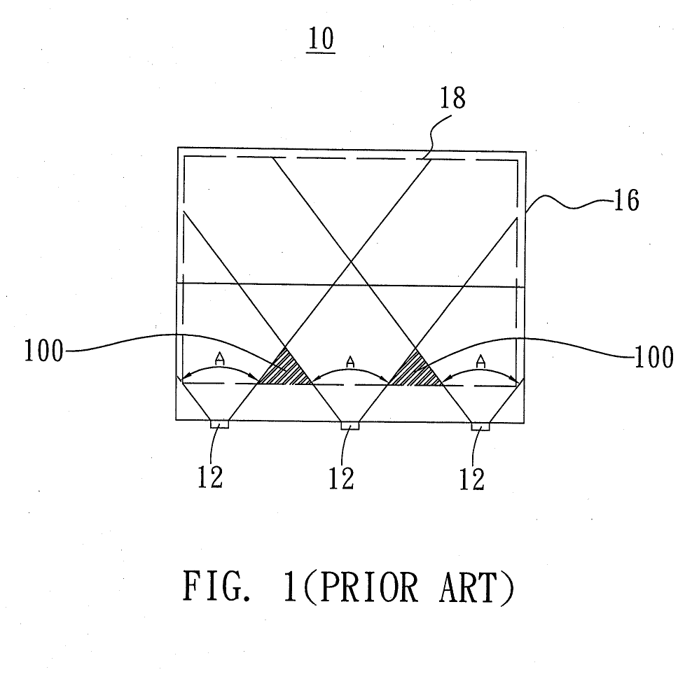

FIG. 2 shows a diagram of luminous region of a prior art backlight module.

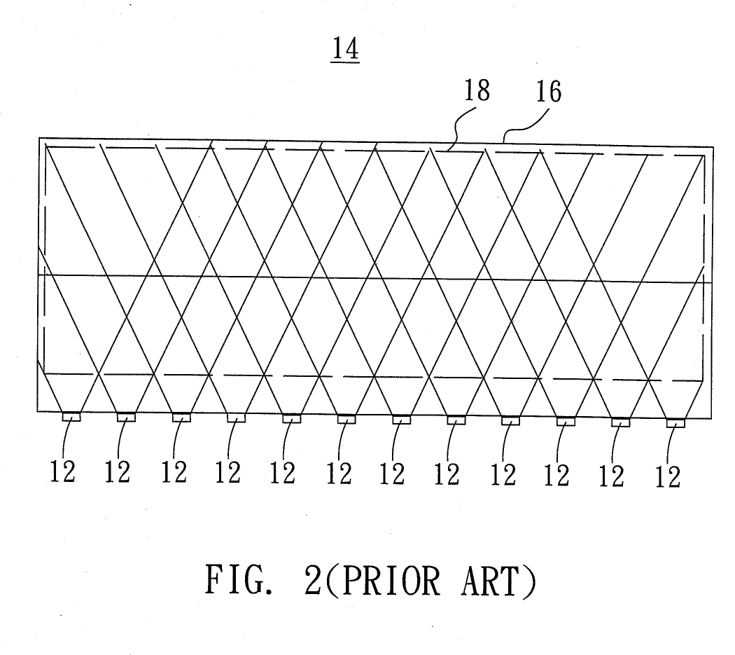

FIG. 3 shows a diagram of luminous region of another prior art backlight module.

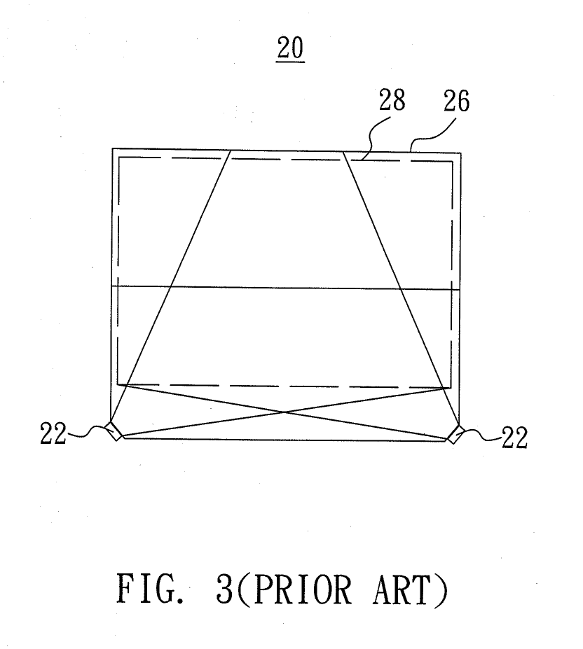

FIG. 4 shows a first embodiment of a backlight module according to the present invention.

FIG. 5 shows a second embodiment of a backlight module according to the present invention.

FIG. 6 shows a third embodiment of a backlight module according to the present invention.

FIG. 7 shows a fourth embodiment of a backlight module according to the present invention.

FIG. 8 shows a fifth embodiment of a backlight module according to the present invention.

FIG. 9 shows a sixth embodiment of a backlight module according to the present invention.

### DETAILED DESCRIPTION OF THE PREFERRED EMBODIMENTS

According to the present invention, a backlight module comprises a bezel and a plurality of light emitting diodes. And, as a skilled person in this art is aware, such optical components as a light guiding plate, a diffusion sheet and a brightness enhancement film are disposed on the backlight module. The light guiding plate guides light emitted from the light source as an even lighted surface. Through the light distribution of the diffusion sheet and light-gathering of the brightness enhancement films, the light is fed into an LCD panel. For simplicity, such components are not shown in the following figures.

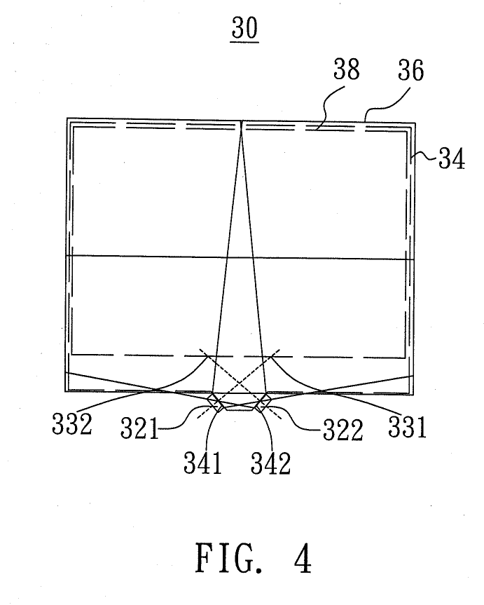

Please refer to FIG. 4 which shows a diagram of a first embodiment of a backlight module 30 according to the present invention. The backlight module 30 comprises a bezel 36, a first light emitting diode (LED) 321 and a second LED 322 disposed at the same side of bezel 36. Light axis 331 of the first LED 321 is not parallel to light axis 332 of the second LED 322. It should be noted that the light axis, hereinafter, indicates a median of the maximum region of luminance of an LED, and the maximum luminance of each LED is in a range of approximate 110 degrees. The maximum luminous region of LEDs 321 and 322, as shown in FIG. 4, are sufficient for the active area 38 to be viewed. Moreover, for better light guiding efficiency, part of the light guiding plate 34 extended outward has incident surfaces 341 and 342 at different spatial surface, so as to comply with the locations and alignments of LEDs 321 and 322. That is, the light axes 331 and 332 of the first LED 321 and the second LED 322 are respectively vertical to the incident surfaces 341 and 342 of the light guiding plate 34 so that the light axis 331 of the first LED 321 and the light axis 332 of the second LED 322 are not parallel.

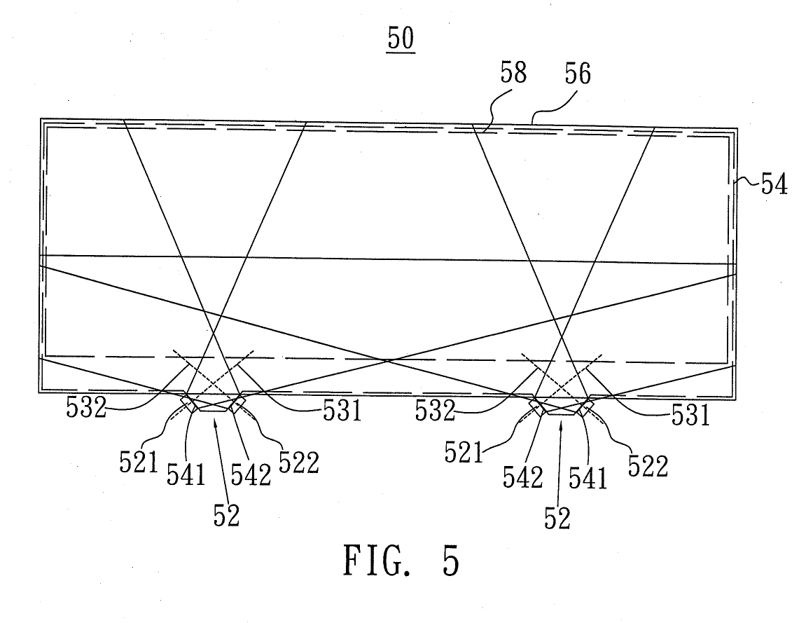

Please refer to FIG. 5, which shows a second embodiment of backlight module 50 according to the present invention. In the second embodiment, using two LEDs is not enough for an active area 58 with a larger viewing region, therefore, backlight module 50 comprises two LED groups 52. Each LED group 52 comprises a first LED 521 and a second LED 522, both of which are disposed at the same side of bezel 56. A light axis 531 of the first LED 521 is not parallel to a light axis 532 of the second LED 522. It should be noted that two LED groups are shown in FIG. 5. As the person skilled in the art is aware, three or more LED groups are also configured if the active area 58 has a larger viewing size. Moreover, for better light guiding efficiency, part of the light guiding plate 54 which is extended outwards has incident surfaces 541 and 542 at different spatial surface, so as to comply with the locations and alignments of the LEDs 521 and 522. That is, the light axes 531 and 532 of the LED 521 and 522 are respectively vertical to the incident surfaces 541 and 542 of the light guiding plate 54 so that the light axis 531 of the first LED 521 and the light axis 532 of the second LED 522 are not parallel.

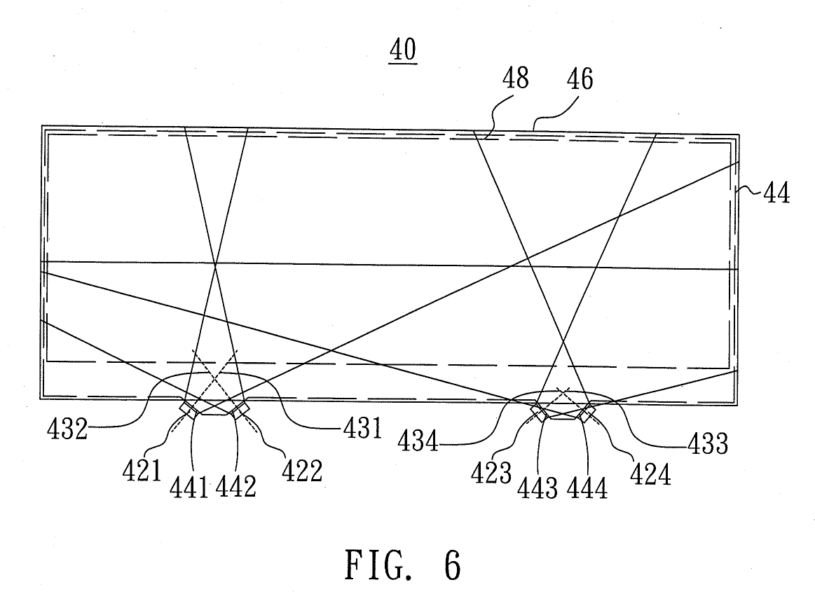

Please refer to FIG. 6, which shows a third embodiment of backlight module 40 according to the present invention. Differing from backlight module 50 shown in FIG. 5, backlight module 40 comprises a first LED 421, a second LED 422, a third LED 423, and a fourth LED 424, all of which are disposed at the same side of bezel 46. Moreover, any selected from a light axis 431 of the first LED 421, a light axis 432 of the second LED 422, a light axis 433 of the third LED 423, and a light axis 424 of the fourth LED 424 is not parallel to each other. It should be noted that four LEDs 421, 422, 423, and 424 are shown in FIG. 6, as the person skilled in the art is aware that five or more LEDs are also configured if the active area 48 has a larger viewing size. In addition, for better light guiding efficiency, part of the light guiding plate 44 which is extended outwards has incident surfaces 441, 442, 443, 444 at different spatial surface, so as to comply with the locations and alignments of LEDs 421, 422, 423, and 424. That is, the light axes 431, 432, 433, 434 of LEDs 421, 422, 423, 424 are respectively vertical to the incident surfaces 441, 442, 443, 444 of the light guiding plate 44, so that any two of the light axes 431, 432, 433, 434 of LEDs 421, 422, 423, 424 are not parallel.

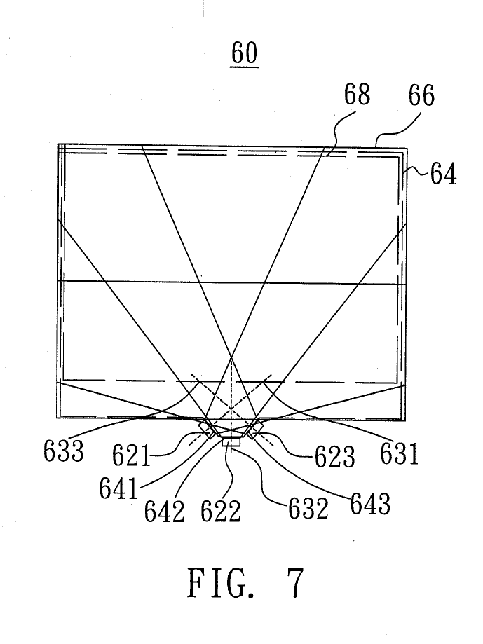

Please refer to FIG. 7, which shows a diagram of a fourth embodiment of a backlight module 60 according to the present invention. The backlight module 60 comprises a first LED 621, a second LED 622, and a third LED 623, all of which are adjacent to and disposed at the same side of bezel 66. Any two light axes selected from a light axis 631 of the first LED 621, a light axis 632 of the second LED 622, and a light axis 633 of the third LED 623 are not parallel. Moreover, for better light guiding efficiency, part of the light guiding plate 64 which is extended outwards has incident surfaces 641, 642, 643 at different spatial surface, so as to comply with the locations and alignments of LEDs 621, 622, and 623. That is, the light axes 631, 632, 633 of the first LED 621, the second LED 622, and the third LED 623 are respectively vertical to the incident surfaces 641, 642, 643 of the light guiding plate 64 so that any two of the light axes 631, 632, 633 of the LEDs 621, 622, 623 are not parallel.

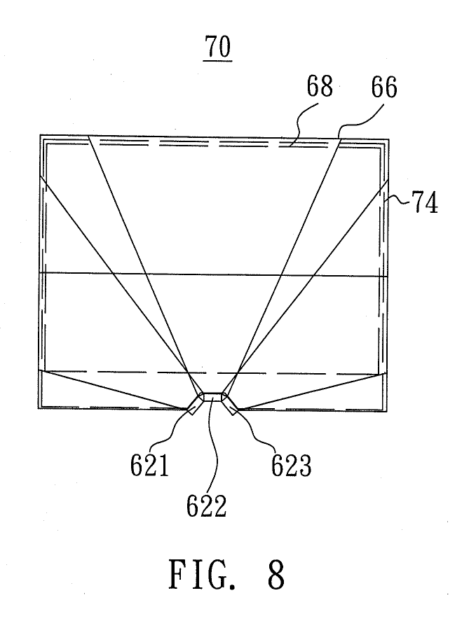

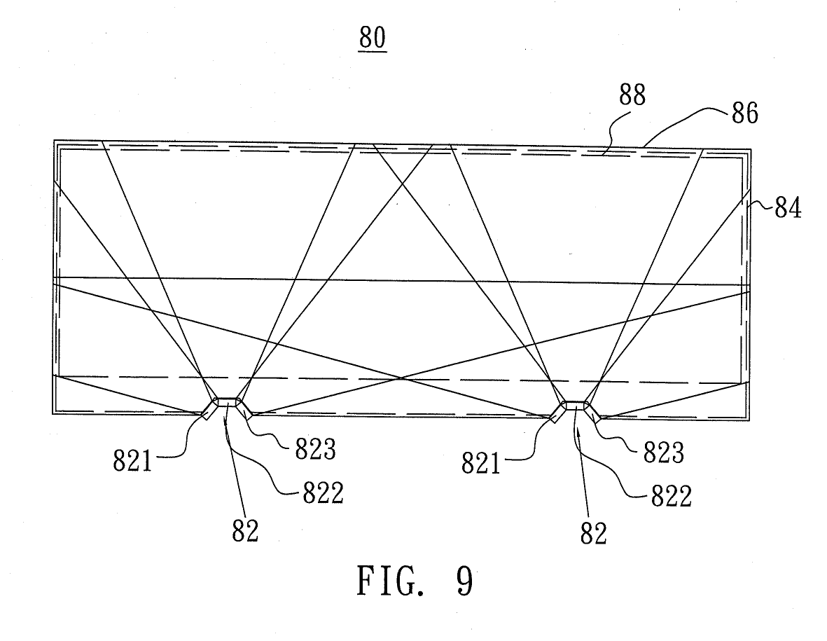

Please refer to FIG. 8, which shows a diagram of a fifth embodiment of a backlight module 70 according to the present invention. A discrepancy between the fifth embodiment of FIG. 8 and the further embodiment of FIG. 9 is the alignment of LEDs 621, 622, 623. Any two light axes selected from a light axis 631 of the first LED 621, a light axis 632 of the second LED 622, and a light axis 633 of the third LED 623 are not parallel as well. Moreover, for better light guiding efficiency, the light guiding plate 74 with an inward indentation has incident surfaces at different spatial surface, so as to comply with the locations and alignments of the LEDs 621, 622, 623. That is, the light axes 631, 632, 633 of the first LED 621, the second LED 622, and the third LED 623 are respectively vertical to the corresponding incident surfaces of the light guiding plate 74 so that any two of the light axes 631, 632, 633 of the LEDs 621, 622, 623 are not parallel.

Please refer to FIG. 9, which shows a sixth embodiment of backlight module 80 according to the present invention. Using three LEDs is not enough for an active area 88 with a larger viewing size, therefore, in the sixth embodiment, the backlight module 80 comprises two LED groups 82. Each of LED group 82 comprises a first LED 821, a second LED 822, and a third LED 823, all of which are disposed at the same side of bezel 86. Any two light axes selected from the three light axes of the first LED 621, the second LED 622, the third LED 623 are not parallel. It should be noted that two LED groups are shown in FIG. 9, as the person skilled in the art is aware, three or more LED groups 82 are also configured if the active area 88 has a larger viewing size. In addition, for better light guiding efficiency, the light guiding plate 84 with an inward indentation has incident surfaces at different spatial surface, so as to comply with the locations and alignments of LEDs 821, 822, and 823. That is, the light axes of LED 821, 822, and 823 are respectively vertical to the incident surfaces of the light guiding plate 84 so that any two of the light axes of the LEDs 821, 822, 823 are not parallel.

In contrast to prior art, the present invention provides a backlight module with plurality of LEDs disposed at one side of a bezel. By adjusting the alignment of the LEDs, using fewer LEDs is sufficient for covering desired viewing region of the active area. Such designation has an advantage of lowering cost and benefiting to mass production.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A backlight module, comprising:
a bezel;
a first light emitting diode disposed at one side of the bezel for emitting light;
a second light emitting diode disposed at the same side of the bezel for emitting light, wherein a light axis of the first light emitting diode is not parallel to a light axis of the second light emitting diode; and
a light guiding plate, disposed on the bezel, for guiding light from the first and second light emitting diodes.

2. The backlight module of claim 1, further comprising a third light emitting diode disposed between the first light emitting diode and the second light emitting diode.

3. The backlight module of claim 2, wherein the third light emitting diode has a light axis which is neither parallel to the light axis of the first light emitting diode nor parallel to the light axis of the second light emitting diode.

4. The backlight module of claim 2, wherein the third light emitting diode is adjacent to the first light emitting diode and the second light emitting diode.

5. The backlight module of claim 2, wherein the light guiding plate further comprises a first incident surface vertical to the light axis of the first light emitting diode, a second incident surface vertical to the light axis of the second light emitting diode, and a third incident surface vertical to the light axis of the third light emitting diode.

6. The backlight module of claim 1, wherein the light guiding plate further comprises a first incident surface vertical to the light axis of the first light emitting diode, and a second incident surface vertical to the light axis of the second light emitting diode.

7. A backlight module, comprising:
a bezel;
a first light emitting diode group, comprising a first light emitting diode and a second light emitting diode disposed at one side of the bezel, wherein the first light emitting diode has a light axis which is not parallel to a light axis of the second light emitting diode;
a second light emitting diode group, comprising a third light emitting diode and a fourth light emitting diode disposed at the same side of the bezel, wherein the third light emitting diode has a light axis which is not parallel to a light axis of the fourth light emitting diode; and
a light guiding plate, disposed on the bezel, for guiding light from the first and second light emitting diode groups.

8. The backlight module of claim 7, wherein the first light emitting diode group further comprises a fifth light emitting diode disposed between the first light emitting diode and the second light emitting diode, and the fifth light emitting diode has a light axis which is neither parallel to the light axis of the first light emitting diode nor parallel to the light axis of the second light emitting diode.

9. The backlight module of claim 8, wherein the light guiding plate further comprises a first incident surface vertical to the light axis of the first light emitting diode, a second incident surface vertical to the light axis of the second light emitting diode, and a third incident surface vertical to the light axis of the fifth light emitting diode, and any two incident surfaces selected from the first incident surface, the second incident surface, and the third incident surface are not parallel.

10. The backlight module of claim 7, wherein the light guiding plate further comprises a first incident surface vertical to the light axis of the first light emitting diode, and a second incident surface vertical to the light axis of the second light emitting diode, and the first incident surface and the second incident surface are not parallel.

11. The backlight module of claim 7, wherein the second light emitting diode group further comprises a sixth light emitting diode disposed between the third light emitting diode and the fourth light emitting diode, the sixth light emitting diode has a light axis which is neither parallel to the light axis of the third light emitting diode nor parallel to a light axis of the fourth light emitting diode.

12. The backlight module of claim 11, wherein the light guiding plate further comprises a fourth incident surface vertical to the light axis of the third light emitting diode, a fifth incident surface vertical to the light axis of the fourth light emitting diode, and a sixth incident surface vertical to the light axis of the sixth light emitting diode, and any two incident surfaces selected from the fourth incident surface, the fifth incident surface, and the sixth incident surface are not parallel.

13. A liquid crystal display incorporating the backlight module of claim 7.

14. A backlight module, comprising:
a bezel;
a plurality of light emitting diode groups disposed at one side of the bezel, each light emitting diode group comprising a first light emitting diode and a second light emitting diode, wherein the first light emitting diode has a light axis which is not parallel to a light axis of the second light emitting diode; and
a light guiding plate, disposed on the bezel, for guiding light from the plurality of light emitting diode groups.

15. The backlight module of claim 14, wherein each light emitting diode group further comprises a third light emitting diode, the third light emitting diode has a light axis which is neither parallel to the light axis of the first light emitting diode nor parallel to the light axis of the second light emitting diode.

16. The backlight module of claim 15, wherein the light guiding plate further comprises a first incident surface vertical to the light axis of the first light emitting diode, a second incident surface vertical to the light axis of the second light emitting diode, and a third incident surface vertical to the light axis of the third light emitting diode, and any two incident surfaces selected from the first incident surface, the second incident surface, and the third incident surface are not parallel.

17. The backlight module of claim 14, wherein the light guiding plate further comprises a first incident surface vertical to the light axis of the first light emitting diode, and a second incident surface vertical to the light axis of the second light emitting diode, and the first incident surface and the second incident surface are not parallel.
